(19) United States
(12) Patent Application Publication
(10) Pub. No.: US 2005/0101716 A1
(43) Pub. Date: May 12, 2005

(54) Liquid microemulsion stabilizer composition for halogen-containing polymers

(76) Inventors: Ilze Bacaloglu, Hamburg, NJ (US); Radu Bacaloglu, Hamburg, NJ (US); Michael H. Fisch, Wayne, NJ (US); Ulrich Stewen, Schwerte (DE); Stuart D. Brilliant, Levittown, NY (US); Kook Jin Bae, Kinnelon, NY (US); Perry M. Reed, Matawan, NJ (US); Julius Fakinlede, Metuchen, NJ (US); Wahib I. Farahat, Harrington Park, NJ (US)

Correspondence Address: CROMPTON CORPORATION, Benson Road, Middlebury, CT, 06749, US

(21) Appl. No.: 10/712,824

(22) Filed: Nov. 12, 2003

(51) Int. Cl. C09K 15/00; C08K 5/04; C08K 3/26

(52) U.S. Cl. 524/425; 524/394; 252/397

(57) ABSTRACT

A liquid microemulsion stabilizer for chlorinated polymers composition for stabilizing halogen-containing polymer comprising: a) a microemulsion of an overbased metal carbonate/carboxylate obtained from the reaction of an oxide and/or hydroxide of a metal selected from the group consisting of sodium, potassium, calcium, magnesium, zinc and mixtures thereof, an aliphatic carboxylic acid in which the aliphatic moiety contains up to about 30 carbon atoms and carbon dioxide in the presence of a solvent for the aliphatic carboxylic acid, a promoter and a microemulsion-forming amount of surfactant; and, b) an organotin stabilizer.

### BACKGROUND OF THE INVENTION

1. Field of the Invention

This invention relates to a liquid stabilizer composition containing an overbased colloidal metal carbonate/carboxylate component and an organotin component and halogen-containing polymers, in particular, polyvinyl chloride (PVC), stabilized therewith.

2. Description of the Related Art

In general, a range of stabilizers can be used to stabilize halogen-containing polymers such as PVC. Typically, compounds containing metals such as, for example, lead, cadmium and barium, have been utilized for this purpose but are problematic from an environmental and toxicological standpoint, particularly in the case of stabilizing nontoxic and FDA compliant PVC articles where the presence of any heavy metal-containing stabilizers is prohibited. Thus, there continues to be a need for effective stabilizers and stabilizer blends (and systems) for PVC and other halogen-containing resins that are substantially free of lead and other heavy metals, which pose environmental, and toxicological problems.

Of great importance in PVC technology is the fact that solid calcium and zinc carboxylate are approved worldwide for stabilizing nontoxic PVC articles, enabling PVC to be used for the manufacture of food contact packaging materials and medical articles, among other items; Plastics Additives Handbook 5^{th} Edition HANSER, p. 452. Attempts to provide such stabilizers in a liquid form to facilitate their handling and incorporation into the resins has been a technologically challenging goal.

Specifically, the use of organotin type stabilizers in conjunction with liquid colloidal Calcium-Zinc type stabilizers (or with Ca and/or Zn liquid intermediates) has been problematic in that they are known to hydrolyze in the presence of small amounts of water, which leads to precipitation and decreased stabilizer performance.

Accordingly, there remains a need for liquid PVC stabilizers representing organotin-calcium/zinc blends with good shelf life and affording good thermal stability for PVC.

Additionally organotin stabilizers are of high cost and consequently it is increasingly desirable to reduce the amount of tin stabilizer to be incorporated in the halogen-containing resin from the standpoint of economical aspects.

For PVC stabilization, the use of PVC stabilizers blends designed to meet specific physical and chemical specifications have also been long known, such as in earlier U.S. Pat. Nos. 5,102,933; 5,322,872 and 5,656,202. The use of organo-tin stabilizers for polyvinyl chloride resins is well known, as, for example, described in U.S. Pat. Nos. 4,041,014; 4,146,518; 4,183,846; 4,255,320; 4,345,045; 4,357,434; RE 30,338; and, RE 32,935.

### SUMMARY OF THE INVENTION

It is an object of the present invention to provide stable, effective blended organo tin-containing liquid stabilizer compositions for the thermal stabilization, i.e., static and dynamic thermal stabilization, of halogen-containing polymers.

It is a particular object of this invention to provide mixed-metal PVC stabilizers containing organotin stabilizer(s) or organotin intermediate(s) for PVC application.

It is a further object of the present invention to provide stabilizer compositions with good shelf life and good heat stability performance while maintaining a low cost of production.

In keeping with these and other objects of the invention, there is provided a liquid stabilizer composition for a halogen-containing polymer, the composition comprising:
a) a microemulsion of an overbased metal carbonate/carboxylate obtained from the reaction of an oxide and/or hydroxide of a metal selected from the group consisting of sodium, potassium, calcium, magnesium, zinc and mixtures thereof, an aliphatic carboxylic acid in which the aliphatic moiety contains up to about 30 carbon atoms and carbon dioxide in the presence of a solvent for the aliphatic carboxylic acid, a promoter and a microemulsion-forming amount of surfactant; and,
b) at least one organotin stabilizer

### DESCRIPTION OF THE PREFERRED EMBODIMENTS

Overbased metal carbonate/carboxylate component (a) of the liquid stabilizer composition herein is obtained from the reaction of a basic metal compound and an aliphatic acid in which the aliphatic moiety contains up to 30 carbon atoms in a solvent and a microemulsion-forming surfactant followed by carbonation in the presence of a promoter with carbon dioxide, as described in co-pending U.S. patent application Ser. No. 10/191,440, filed Jul. 8, 2002 the contents of which are incorporated by reference herein.

The metal carbonate/carboxylate microemulsions are prepared conventionally by carbonation of the foregoing components in solvent which can be oil at suitable temperatures, e.g., about 100° C. to about 220° C. and preferably at about 140° C. to about 210° C., such that the viscosity of the microemulsion does not become exceedingly high, i.e., a viscosity not exceeding about 10,000 cP. Following the reaction, the product can be purified from solid impurities employing known and conventional means, e.g., filtration.

Suitable basic metal compounds for use herein include, calcium oxide, calcium hydroxide, magnesium oxide, magnesium hydroxide, sodium hydroxide, potassium hydroxide, zinc oxide, zinc hydroxide and the like, and combinations thereof. Calcium hydroxide and zinc oxide are generally preferred.

The carboxylic aliphatic acid can include both saturated and unsaturated containing functional groups up to about 30 carbon atoms and preferably from about 6 to about 16 carbon atoms. Suitable aliphatic acids include, caprylic acid, capric acid, lactic acid, lauric acid, myristic acid, myristoleic acid, decanoic acid, dodecanoic acid, pentadecanoic acid, palmitic acid, palmitoleic acid, margaric acid, stearic acid, 12-hydroxystearic acid, oleic acid, ricinoleic acid, linoleic acid, arachidic acid, gadoleic acid, eicosadienoic acid, behenic acid, erucic acid, tall oil fatty acids, rapeseed oil fatty acid, linseed oil fatty acid, and the like, and mixtures thereof. Preferred aliphatic acids for use herein are oleic acid and tall oil fatty acids.

Generally, the overbased liquid colloidal metal carbonate/carboxylate(s) are microemulsions, of generally homogeneous appearance, characterized by a metal content in excess of that which would be present according to the stoichiometry of the metal and the particular aliphatic acid reacted with the metal. Suitable metal carbonates/carboxylates for use herein include, calcium carbonate, calcium carboxylate, zinc carbonate, zinc carboxylate, etc., and mixtures thereof. The amount of excess metal is commonly expressed in terms of metal ratio. The term “metal ratio” is the ratio of the total equivalents of the metal to the equivalents of the aliphatic acid. A neutral metal salt has a metal ratio of one. A salt having 4.5 times as much metal as present in a neutral salt will have metal excess of 3.5 equivalents, or a ratio of 4.5. The ratios between the metal carbonate to metal carboxylate is about 0.2 to about 10, preferably from about 0.5 to about 7 and most preferably from about 0.7 to about 5.

As one skilled in the art will readily appreciate, the overbased metal carbonate/carboxylate is prepared by reacting a mixture containing at least a stoichiometric excess of the foregoing basic metal compound(s), any of the foregoing aliphatic acid(s), solvent(s), promoter(s) and surfactant(s) with gaseous carbon dioxide.

The amount of carbon dioxide gas used depends in some respects upon the desired basicity of the product in question and also upon the amount of basic metal compound employed which, as discussed above, will vary (in total amount) from about 1 to about 10, preferably from about 1.2 to about 8 and most preferably from about 1.7 to about 6.0 equivalents per equivalent of aliphatic acid(s). The carbon dioxide gas is generally introduced below the surface of the reaction mixture that contains additional (i.e., amounts in excess of what is required to convert the aliphatic acid quantitatively to the metal carboxylate salt) base after the metal carboxylate intermediate is formed. The process of carbonation, which is a part of the process of obtaining the metal carbonate/carboxylate, is well known to those skilled in the art. The carbon dioxide gas is used to react with the excess basic metal compound which may be already present or which can be added during this step. The mixtures of products obtained after carbonation are referred to herein as metal carbonates/carboxylates and include, e.g., calcium carbonate formed from the reaction of carbon dioxide with calcium hydroxide and zinc carbonate formed from the reaction of carbon dioxide with zinc oxide and/or a mixture of metal hydroxides reacting with carbon dioxide.

Component (a) can contain a calcium intermediate, which can be colloidal calcium carbonate/oleate with calcium being 5-11% by weight. Component (a) can also include colloidal calcium carbonate/tallate in the range of 5-11% by weight calcium. Component (a) can also include colloidal zinc carbonate/oleate in 4-10% by weight zinc as well as zinc carbonate/tallate in 5-10% by weight zinc. Still further, component (a) can include a calcium and/or zinc carboxylate.

An important component of the metal carbonate/carboxylate microemulsion forming reaction medium is a promoter(s) or a phase transfer catalyst(s). Promoters are advantageously employed in the carbonation process to facilitate the incorporation of the large excess of basic metal compound into the aqueous micro-droplets of the microemulsion. Suitable promoters include one or more non-phenolic compounds containing about 2 or more hydroxyl groups and preferably about 2 or about 3 hydroxyl groups. Examples of these compounds include, but are not limited to, glycerin, glycerol monooleate, diethylene glycol, triethylene glycol, dipropylene glycol, tripropylene glycol, diethylene glycol monobutyl ether, triethanolamine, diethanolamine, ethanolamine, etc and the like. A preferred promoter for use herein is glycerin. Amounts of promoter will ordinarily range from about 1% to about 25%, preferably from about 1.5% to about 20% and most preferably from about 2% to about 7% of acid charge. Amounts of the phase transfer catalysts can vary widely, e.g., ranging from about 1% to about 25%, preferably from about 1.5% to about 20% and most preferably from about 2% to about 16% of the acid charge.

The solvent(s) used for preparing the metal carbonate/carboxylates will normally be an inert solvent for the aliphatic acid. Solvents which can be employed herein include oils and, optionally, an organic material which is readily soluble or miscible with oil. It is particularly advantageous to employ a high boiling, high molecular weight solvent, so as to be used in low volatile organic components and low “fogging” PVC stabilizers. Suitable high boiling, high molecular weight solvents for use herein include parrafinic oils having boiling points higher than about 120° C. Commercially available oils of this type known to one skilled in the art include, e.g., those available from such sources as Exxon under the Isopar® trade names, e.g., Isopar® M, Isopar® G, Isopar® H, and Isopar® V, and Telura® trade name, e.g., Telura® 407, and Crompton Corporation available as Carnation oil and the like. Suitable organic solvents include unsubstituted or substituted aromatic hydrocarbons, ethoxylated long chain alcohols, e.g., those ethoxylated alcohols having up to about 20 carbon atoms, and mixtures thereof. Useful unsubstituted or substituted aromatic hydrocarbons include high flash solvent naphtha and the like.

The reduced tendency of a halogen-containing polymer (such as PVC resin) compound to form “fog” in use is also expressed herein as a reduced tendency of the resin additives to volatilize, by which is meant that the resin manufactured products emits a reduced amount of, and preferably little or no, volatile compounds into the ambient atmosphere when the resin is exposed to moderate heat, typically temperatures ranging from, for example, about 60° to about 130° C. (1400 to 270° F.). Such compounds emitted by PVC resin manufactured products under such conditions can comprise one or more components of the additives used in the manufacture of PVC, products of the degradation of one more of these additives, compounds formed by the reaction of any such emitted compounds or degradation products, or mixtures of any of the foregoing.

Another part of component (a) of the liquid microemulsion stabilizer-forming reaction medium is a surfactant numerous ones of which find use herein. Among the surfactants, which can be advantageously employed are one or more polyols and/or alcohol ethoxylates and/or alcohol propoxylates having from about 6 to about 24 carbon atoms in the parent alcohol and 0 to 3 ethylene oxide units and/or 0 to 3 propylene oxide. Compounds of this type include, but are not limited to, high molecular weight alcohols, e.g., those having a molecular weight greater than about 186. Suitable surfactants for use herein also include sorbitol, pentaerythritol, sugar alcohols, their alkoxylated derivatives, mixtures thereof and the like. A preferred surfactant for use herein is sorbitol. Other useful surfactants are long chain ethoxylated alcohols, i.e., those having up to at least about 20 carbon atoms, and include commercially available alcohols such as those available from such sources as Shell under the Neodol tradenames, e.g., Neodol® 23.1, Neodol® 25.1 and the like and Condea Vista under the Alfol tradename, e.g., Alfol® 1216.15 and the like. The surfactants can be employed in a microemulsion-forming amount ranging from about 0.5% weight to about 25% weight, preferably from about 1% weight to about 10% weight and most preferably from about 3% weight to about 8% weight.

Component (b) of the present liquid stabilizer compositions is an organotin stabilizer for halogen-containing polymers such as PVC Many of such stabilizers are known in the art as well as methods for their preparation. See, e.g., U.S. Pat. Nos. 3,454,610; 3,459,779; 3,862,198; 3,971,817; 4,148,814; 4,269,782; 4,434,102; 4,222,950; 4,282,165; 4,510,095; and 4,604,475 the contents of which are herein incorporated by reference.

Preferred organotin stabilizers include alkyl tin carboxylates of aliphatic or aromatic acids, and alkyltin mercaptides possessing alkyl groups of from 1 to about 30 carbon atoms, e.g., methyl, butyl, octyl and mixtures thereof. Among the more preferred alkyl mercaptide stabilizers are methyltin tris (2-ethylhexyl thioglycolate), dimethyltin bis (2-ethylhexyl thioglycolate), butyltin tris (lauryl mercaptide), dioctyl tin bis (isooctyl thioglycolate), octyltin tris (isooctyl thioglycolate) and mixtures thereof.

Preferred alkyltin carboxylates include, e.g. methyltin tris(2-ethyl hexyl maleate), dimethyltin bis(2-ethyl hexyl maleate), dibutyltin bis(isooctyl maleate), mixtures thereof and the like.

The weight ratio of component (a) to (b) is in an effective amount to form homogeneous stable liquid mixture and to prevent precipitation. The general weight ratio of component (a) to (b) varies depending on which particular calcium or zinc carbonate/carboxylate and organotin are used, but the ratio of (a) to (b) is generally from about 99:1 to about 1:99. The preferred range is from about 10:90 to about 90:10, with the most preferred range being from about 20:80 to about 50:50.

In addition to components (a) and (b) as described above, if necessary some of the following additional ingredients can be added including solvents, epoxies such as epoxidized soybean oil or epoxidized linseed oil, β-diketones, organic phosphites, antioxidants, radical scavengers, optical brighteners, light stabilizers, perchlorates, fillers, plasticizers, impact modifiers, pigments and admixtures thereof. Such intermediates are conventionally employed in liquid stabilizer compositions and are readily recognized by those of skill in the art.

Preferably solvents include process oil, Isopar M, carnation oil, alcohols and their ethoxylated derivatives for low VOC stabilizers and/or OMS and other solvents for stabilizers without low VOC requirements.

Examples of β-diketones are dibenzoyl methane, stearoyl benzoyl methane, distearoyl methane, and the like. Examples of organic phosphites compounds are aromatic phosphites, such as triphenyl phosphite, diphenyl phosphite, tris nonylphenyl phosphite; and the like, aliphatic phosphites, such as triisodecyl phosphite and tri-2-ethylhexyl phosphite; and the like, and aliphatic-aromatic phosphates such as diphenyl isodecyl phosphite, phenyl diisodecyl phosphite, isooctyl diphenyl phosphite, 2-ethylhexyl diphenyl phosphite, and the like.

Examples of other metal carboxylate stabilizer components are calcium lactate, calcium oleate, calcium 2-ethyl hexanoate, zinc 2-ethyl hexanoate, zinc oleate, and the like. Examples of antioxidants as components of the stabilizer compositions stabilizer components are commercially available antioxidants such as 2,2-bis-(p-hydroxyphenyl) propane, 1,1,3-tris-(2-methyl-4-hydroxy-5-t-butyl phenyl)butane, octadecyl-3,5-di-t-butyl-4-hydroxyhydrocinnamate, tetrakis-[methylene (3,5 di-t-butyl-4-hydroxyhydrocinnamate)]methane, and the like. Examples of radical scavengers are commercial HALS (hindered amine light stabilizers) such as Tinuvin® 770, Chimasorb® 944 (available from CibaSC), Mark Screen HA-7770, MarkScreen HA-7944, (available from Crompton Corporation), Chimasorb UV-3346, Cyasorb UV 3581 (Cytec) and Lovilite® 76 (Great Lakes), and the like.

The stabilized halogen-containing organic polymers, e.g., stabilized polyvinyl chloride resin compositions, comprising these components can also contain conventional additional additives such as lubricants, flame retardants, fillers, pigments, antioxidants, ultraviolet light stabilizers, blowing agents, impact modifiers, processing aids, plasticizers, and admixture thereof. and the like, in relative amounts effective to fulfill the desired functions of each such ingredient. These ingredients can be added, if desired, prior to, during, or subsequent to the step in which the micro emulsion of the present invention or its mixtures with other stabilizer components is compounded into the polyvinyl chloride resin composition.

Examples of lubricants are those selected from the group consisting of paraffin waxes, polyethylene waxes, carboxylic acids, amide lubricants, ester lubricants, ester waxes, metal carboxylates, silicone-based lubricants and combinations thereof.

Examples of fillers can be one or more of the group consisting of dolomite, wollastonite, silicates, clay, talc, glass fibers, glass beads, wood flour, mica, carbon black, graphite, rock flour, heavy spar, talc, kaolin and chalk, and the like.

Examples of pigments can be those selected from the group consisting of TiO₂, zirconium oxide-based pigments, BaSO₄, zinc oxide (zinc white) and lithopones (zinc sulfide/barium sulfate), carbon black, carbon black/titanium dioxide mixtures, iron oxide pigments, Sb₂O₃, (Ti, Ba, Sb) O₂, Cr₂O₃ spinels, such as cobalt blue and cobalt green, Cd (S, Se), ultramarine blue, organic pigments, for example, azo pigments, phthalo-cyanine pigments, quinacridone pigments, perylene pigments, diketopyrrolopyrrole pigments and anthraquinone pigments, and the like.

Examples of processing aids are commercially available processing aids available from such sources as Rohm and Haas under the Paraloid® tradename, e.g., Paraloid® K-120N, Paraloid® K-125175, Paraloid® K-147, Elf Atochem under the Metablen® tradename, e.g., Metablen® P-501 and Metablen® P-550, and the like.

Examples of impact modifiers are commercially available. Organic impact modifiers such as ABS types, MBS types, All-acrylic types, CPE types, EVA types and inorganic impact modifiers such as CaCO3 and aluminum trihydrate. The organic impact modifiers are available from such sources as Rohm and Haas under the Paraloid® tradename, e.g., Paraloid® BTA-715, Paraloid® BTA-733, Paraloid® BTA-753, and Kaneka America Corporation under the Kane Ace® tradename, e.g., Kane Ace® B-52, Kane Ace® B-51, Kane Ace® B-58, and Dow Chemical Company under the Tyrene® tradename, e.g., Tyrene® 3615, and Tyrin 3614A.

The microemulsions compositions are preferably used to advantage in combination with halogen-containing organic polymers, e.g., halogen-containing plastic materials, to form the stabilized halogen-containing organic polymers. These halogen-containing organic polymers include homopolymers such as the polyvinyl chloride-type polymers, e.g., polyvinyl chloride and polyvinylidene chloride. These polymers can also include those polymers formed by the copolymerization of vinyl chloride with other unsaturated monomers. Unsaturated monomers can be compounds which contain polymerizable carbon-to-carbon double bonds and include, for example, alpha olefins such as, e.g., ethylene, propylene and 1-hexene; acrylates such as, e.g., acrylic acid, ethyl acrylate and acrylonitrile; vinyl monomers such as, e.g., styrene and vinyl acetate and/or maleates such as, e.g., maleic acid, maleic anhydrides and maleic esters; and combinations thereof. Particularly preferred resins to which the compounds of this invention are added are the chlorine-containing polymers, particularly PVC, and compositions containing these resins.

The microemulsion compositions of the present invention can also be used with plasticized polyvinyl chloride resin compositions of conventional formulation. Conventional plasticizers well known to those skilled in the art can be employed. Examples of such plasticizers are phthalates, esters of aliphatic dicarboxylic acids, trimellitates, epoxy plasticizers, polymer plasticizers and phosphoric esters.

Generally, the microemulsions compositions are used in amounts effective to impart static and dynamic thermal stability, i.e., resistance to heat-mediated deterioration of the halogen-containing polymers such as PVC or other polyvinyl chloride resin and compositions obtained therefrom of the present invention. That is, “heat-mediated deterioration” includes deterioration which is due to exposure to excessive heat, as well as deterioration which is initiated or accelerated by exposure to heat. Effective static and dynamic thermal stability is afforded generally by adding an effective heat stabilizing amount ranging from about 0.5 to about 10 and preferably from about 0.8 to about 5 and preferably from about 1 to about 3 parts per hundred parts resin (phr). These microemulsion compositions of metal carbonate/carboxylate can be added to the chlorine containing resin as such or in mixtures with the other types of intermediates for stabilizers as discussed above.

Furthermore a process for preparing a stabilizer composition useful as a thermal stabilizer for halogen-containing resins which exhibit reduced amounts of precipitation when hydrolyzed and maintain early color hold when heated comprising the steps of combining component (a) and (b) of the above-identified liquid microemulsion stabilizer.

The following non-limiting examples are illustrative of the present invention.

### EXAMPLE 1

The following tables use the notation defined as follows:

Liquid Microemulsion of Overbased Calcium/Zinc (Component (a))

Colloidal Calcium carbonate/oleate version 1 Ca=9-11% (CCO) or Ca=5-7% (CCOD)
Colloidal Calcium carbonate/oleate version 2 Ca=9-11% (CAP-23) or Ca—5-7% (CAP-23D)
Colloidal Calcium carbonate/tallate Ca=8-11% (CCT)
Colloidal Zinc carbonate/oleate Zn=9-10% (ZCO)
Colloidal Zinc carbonate/tallate Zn=9-10% (ZCT)
Zinc carboxylate (ZC-OXY)
   Organotin Stabilizer (Component (b))
OTSA: Mixture of methyltin tris(2-ethylhexyl thioglycolate) and dimethyltin bis (2-ethylhexyl thioglycolate)
OTSB: Mixture of methyltin tris(2-ethylhexyl thioglycolate) and dimethyltin bis (2-ethylhexyl thioglycolate)
OTSC: Mixture of methyltin tris(2-ethylhexyl thioglycolate) and dimethyltin bis (2-ethylhexyl thioglycolate)
OTSD: Butyltin tris(lauryl mercaptide)
OTSE: Mixture of dioctyltin bis(isooctyl thioglycolate) and octyltin tris(isooctyl thioglycolate)

The types of stabilizers as listed in the following tables (Tables 1 to 13) and the afforded heat stability performances of the PVC compounds are compared via blackening time in Table 14.

Examples of Stabilizers:

TABLE 1
Sn/Ca type stabilizers with OTSA and CCT

| Type No. | OTSA (%) | CCT (%) | Stabilizer ID |
|---|---|---|---|
| 1 | 90 | 10 | Sn/Ca-1 |
| 2 | 85 | 15 | Sn/Ca-2 |
| 3 | 80 | 20 | Sn/Ca-3 |
| 4 | 75 | 25 | Sn/Ca-4 |
| 5 | 65 | 35 | Sn/Ca-5 |
| 6 | 50 | 50 | Sn/Ca-6 |

TABLE 2
Sn/Ca type stabilizers with OTSA and CCO

| No. | OTSA (%) | CCO (%) | Stabilizer ID |
|---|---|---|---|
| 7 | 90 | 10 | Sn/Ca-7 |
| 8 | 85 | 15 | Sn/Ca-8 |
| 9 | 80 | 20 | Sn/Ca-9 |
| 10 | 75 | 25 | Sn/Ca-10 |
| 11 | 70 | 30 | Sn/Ca-11 |
| 12 | 65 | 35 | Sn/Ca-12 |
| 13 | 60 | 40 | Sn/Ca-13 |
| 14 | 55 | 45 | Sn/Ca-14 |
| 15 | 50 | 50 | Sn/Ca-15 |

TABLE 3
Sn/Ca type stabilizers with OTSA, OTSB and CCO

| No. | OTSA (%) | OTSB (%) | CCO (%) | Stabilizer ID |
|---|---|---|---|---|
| 16 | 78.4 | 9.8 | 11.8 | Sn/Ca-16 |
| 17 | 80 | 10 | 10 | Sn/Ca-17 |

TABLE 4
Sn/Ca type stabilizers with OTSB and CCT

| No. | Mark OTSB (%) | CCT (%) | Stabilizer ID |
|---|---|---|---|
| 18 | 75 | 25 | Sn/Ca-18 |
| 19 | 70 | 30 | Sn/Ca-19 |
| 20 | 60 | 40 | Sn/Ca-20 |
| 21 | 55 | 45 | Sn/Ca-21 |
| 22 | 50 | 50 | Sn/Ca-22 |

TABLE 5
Sn/Ca type stabilizers with OTSB and CCO

| No. | Mark OTSB (%) | CCO (%) | Stabilizer ID |
|---|---|---|---|
| 23 | 75 | 25 | Sn/Ca-23 |
| 24 | 50 | 50 | Sn/Ca-24 |

TABLE 6
Sn/Ca type stabilizers with OTSC and CCO

| No. | OTSC (%) | CCO (%) | Stabilizer ID |
|---|---|---|---|
| 25 | 85.7 | 14.3 | Sn/Ca-25 |
| 26 | 75 | 25 | Sn/Ca-26 |
| 27 | 50 | 50 | Sn/Ca-27 |

TABLE 7
Sn/Ca type stabilizers with OTSB and CCOD

| No. | OTSB (%) | CCOD (%) | Stabilizer ID |
|---|---|---|---|
| 28 | 79.3 | 20.7 | Sn/Ca-28 |
| 29 | 65.6 | 34.4 | Sn/Ca-29 |
| 30 | 38.8 | 61.2 | Sn/Ca-30 |

TABLE 8
Sn/Ca type stabilizers with OTSC and CAP-23

| No. | OTSC (%) | CAP 23 (%) | Stabilizer ID |
|---|---|---|---|
| 31 | 85.7 | 14.3 | Sn/Ca-31 |
| 32 | 75 | 25 | Sn/Ca-32 |
| 33 | 50 | 50 | Sn/Ca-33 |

TABLE 9
Sn/Ca type stabilizers with OTSC and CAP-23D

| No. | OTSC (%) | CAP-23D (%) | Stabilizer ID |
|---|---|---|---|
| 34 | 76.9 | 23.1 | Sn/Ca-34 |
| 35 | 62.4 | 37.6 | Sn/Ca-35 |
| 36 | 35.7 | 64.3 | Sn/Ca-36 |

TABLE 10
Sn/Ca/Zn type stabilizers with OTSA, CCT and Z-COXY

| No. | OTSA (%) | CCT (%) | Z-COXY (%) | Stabilizer ID |
|---|---|---|---|---|
| 37 | 50 | 45 | 5 | Sn/Ca-37 |
| 38 | 50 | 40 | 10 | Sn/Ca-38 |

TABLE 11
Sn/Ca/Zn type stabilizers with Mark OTSA, CCT and ZCT

| No. | OTSA (%) | CCT (%) | ZCT (%) | Stabilizer ID |
|---|---|---|---|---|
| 39 | 50 | 45 | 5 | Sn/Ca-39 |
| 40 | 50 | 40 | 10 | Sn/Ca-40 |

TABLE 12
Sn/Ca type stabilizers with Mark OTSD and CCT

| No. | OTSD (%) | CCT (%) | Stabilizer ID |
|---|---|---|---|
| 41 | 50 | 50 | Sn/Ca-41 |

TABLE 13
Sn/Ca type stabilizers with Mark OTSE and CCO

| No. | OTSE (%) | CCO (%) | Stabilizer ID |
|---|---|---|---|
| 42 | 50 | 50 | Sn/Ca-42 |

The new types of stabilizers were tested with generic rigid or flexible PVC formulations as presented in Tables 14, 15 and 16. The performances of the new stabilizers were evaluated by static (oven at 190° C.) and dynamic (Brabender: 190° C., 60 rpm, 65 g) heat stability tests and some examples are summarized in the tables below. The heat stability performances are presented via the blackening time expressed in minutes. In each case at the same use level the early color hold of PVC afforded by the new stabilizers is comparable with the corresponding organotin stabilizers

TABLE 14
Examples of heat stability test results

| | | Stabilizer | | | Control Stabilizers | | | |
|---|---|---|---|---|---|---|---|---|
| | | | | Blackening | | | | Blackening |
| Formulation: | | | | time | | At | | time |
| Rigid PVC | Test | Type | phr | (minutes) | Type | equal*: | phr | (minutes) |
| Clear bottle | D | Sn/Ca-4 | 1.5 | 22 | OTSA | W | 1.5 | 22 |
| | | | | | | Sn | 1.13 | 16 |
| | D | Sn/Ca-10 | 1.5 | 22 | OTSA | W | 1.5 | 22 |
| | | | | | | Sn | 1.13 | 16 |
| | D | Sn/Ca-6 | 1.5 | 22 | OTSA | W | 1.5 | 22 |
| | | | | | | Sn | 0.75 | 12 |
| | D | Sn/Ca/Zn- | 1.5 | 14 | OTSA | W | 1.5 | 22 |
| | | 37 | | | | Sn | 0.75 | 12 |
| | D | Sn/Ca/Zn- | 1.5 | 12 | OTSA | W | 1.5 | 22 |
| | | 38 | | | | Sn | 0.75 | 12 |
| | D | Sn/Ca/Zn- | 1.5 | 18 | OTSA | W | 1.5 | 22 |
| | | 39 | | | | Sn | 0.75 | 12 |
| | D | Sn/Ca/Zn- | 1.5 | 14 | OTSA | W | 1.5 | 22 |
| | | 40 | | | | Sn | 0.75 | 12 |
| Siding | D | Sn/Ca-4 | 1.25 | 24 | OTSA | W | 1.25 | 27 |
| (Capstock) | | | | | | Sn | 0.94 | 21 |
| | D | Sn/Ca-10 | 1.25 | 27 | OTSA | W | 1.25 | 27 |
| | | | | | | Sn | 0.94 | 21 |
| | D | Sn/Ca-6 | 1.25 | 24 | OTSA | W | 1.25 | 27 |
| | | | | | | Sn | 0.63 | 20 |
| | D | Sn/Ca/Zn- | 1.25 | 24 | OTSA | W | 1.25 | 27 |
| | | 37 | | | | Sn | 0.63 | 20 |
| | D | Sn/Ca/Zn- | 1.25 | 19 | OTSA | W | 1.25 | 27 |
| | | 38 | | | | Sn | 0.63 | 20 |
| | D | Sn/Ca/Zn- | 1.25 | 23 | OTSA | W | 1.25 | 27 |
| | | 39 | | | | Sn | 0.63 | 20 |
| | D | Sn/Ca/Zn- | 1.25 | 18 | OTSA | W | 1.25 | 27 |
| | | 40 | | | | Sn | 0.63 | 20 |

*At equal weight (W) or equal tin content (Sn)

TABLE 15
Examples of PVC testing

| | | Stabilizer | | | Control Stabilizers | | | |
|---|---|---|---|---|---|---|---|---|
| | | | | Blackening | | | | Blackening |
| Formulation | | | | time | | At | | time |
| Rigid PVC | Test | Type | phr | (minutes) | Type | equal* | phr | (minutes) |
| Clear bottle | D | Sn/Ca- | 1.2 | 24 | OTSB | W | 1.2 | 27 |
| | | 20 | | | | | | |
| | D | Sn/Ca- | 1.2 | 28 | OTSB | W | 1.2 | 27 |
| | | 18 | | | | | | |
| | D | Sn/Ca- | 1.2 | 27 | OTSB | W | 1.2 | 27 |
| | | 22 | | | | | | |

*At equal weight (W) or equal tin content (Sn)

TABLE 16
Examples of PVC testing

| | | Stabilizer | | | Control Stabilizers | | | |
|---|---|---|---|---|---|---|---|---|
| Formulation | | | | Blackening | | | | Blackening |
| Flexible | | | | time | | At | | time |
| PVC | Test | Type | phr | (minutes) | Type | equal* | phr | (minutes) |
| Clear | S | Sn/Ca- | 1.0 | 50 | OTSE | W | 1.0 | 60 |
| tubing | | 42 | | | | Sn | 0.5 | 40 |

*At equal weight (W) or equal tin content (Sn)

Although the present invention has been described in preferred forms with a certain degree of particularity, many changes and variations are possible therein and will be apparent to those skilled in the art after reading the foregoing description. It is therefore to be understood that the present invention may be practiced otherwise than as specifically described herein without departing from the spirit and scope thereof.

1. A stabilizer composition comprising:
a) a microemulsion of an overbased metal carbonate/carboxylate obtained from the reaction of an oxide and/or hydroxide of a metal selected from the group consisting of sodium, potassium, calcium, magnesium, zinc and mixtures thereof, an aliphatic carboxylic acid in which the aliphatic moiety contains up to about 30 carbon atoms and carbon dioxide in the presence of a solvent for the aliphatic carboxylic acid, a promoter and a microemulsion-forming amount of surfactant; and,
b) at least one organotin stabilizer.

2. The stabilizer composition of claim 1 in which the metal carbonate/carboxylate is selected from the group consisting of calcium carbonate, calcium carboxylate, zinc carbonate, zinc carboxylate and mixtures thereof.

3. The stabilizer composition of claim 1 in which the carboxylate group is derived from an aliphatic carboxylic acid selected from the group consisting of caprylic acid, capric acid, lactic acid, lauric acid, myristic acid, myristoleic acid, decanoic acid, dodecanoic acid, pentadecanoic acid, palmitic acid, palmitoleic acid, margaric acid, stearic acid, 12-hydroxystearic acid, oleic acid, ricinoleic acid, linoleic acid, arachidic acid, gadoleic acid, eicosadienoic acid, behenic acid, erucic acid, tall oil fatty acids, rapeseed oil fatty acid, linseed oil fatty acid and mixtures thereof.

4. The stabilizer composition of claim 2 in which the carboxylate group is derived from an aliphatic carboxylic acid selected from the group consisting of caprylic acid, capric acid, lactic acid, lauric acid, myristic acid, myristoleic acid, decanoic acid, dodecanoic acid, pentadecanoic acid, palmitic acid, palmitoleic acid, margaric acid, stearic acid, 12-hydroxystearic acid, oleic acid, ricinoleic acid, linoleic acid, arachidic acid, gadoleic acid, eicosadienoic acid, behenic acid, erucic acid, tall oil fatty acids, rapeseed oil fatty acid, linseed oil fatty acid and mixtures thereof.

5. The stabilizer composition of claim 1 in which the surfactant is selected from the group consisting of sorbitol, pentaerythritol, sugar alcohols and mixtures thereof.

6. The stabilizer composition of claim 1 in which the organotin stabilizer is an alkyltin carboxylate, alkyltin mercaptide, or mixture thereof in which the alkyl groups contain from 1 to about 30 carbon atoms.

7. The stabilizer composition of claim 6 wherein the alkyltin mercaptide is selected from the group consisting of methyltin tris (2-ethylhexyl thioglycolate), dimethyltin bis (2-ethylhexyl thioglycolate), butyltin tris (lauryl mercaptide), dioctyl tin bis (isooctyl thioglycolate), octyltin tris (isooctyl thioglycolate) and mixtures thereof.

8. The stabilizer composition of claim 6 wherein the alkyltin carboxylate is selected from the group consisting of methyltin tris(2-ethyl hexyl maleate), dimethyltin bis(2-ethyl hexyl maleate), dibutyltin bis (isooctyl maleate) and mixtures thereof.

9. The stabilizer composition of claim 1 wherein the weight ratio of (a) to (b) is from about 99:1 to about 1:99.

10. The stabilizer composition of claim 1 wherein the weight ratio of (a) to (b) is from about 10:90 to about 90:10.

11. The stabilizer composition of claim 1 wherein the weight ratio of (a) to (b) is from about 20:80 to about 50:50.

12. The stabilizer composition of claim 1 comprising at least one additional component selected from the group consisting of solvents, epoxies, α-diketones, organic phosphites, antioxidants, radical scavengers, optical brighteners, light stabilizers, perchlorates, fillers, plasticizers, impact modifiers and pigments.

13. The stabilizer composition of claim 12 wherein the solvent is a paraffinic oil having a boiling point higher than about 120° C.

14. The stabilizer composition of claim 12 wherein the equivalent ratio of basic metal compound to aliphatic acid is about 1 to about 10.

15. A halogen-containing polymer composition comprising a halogen-containing polymer and a stabilizing amount of a stabilizer composition comprising:
a. a microemulsion of an overbased metal carbonate/carboxylate obtained from the reaction of an oxide and/or hydroxide of a metal selected from the group consisting of sodium, potassium, calcium, magnesium, zinc and mixtures thereof, an aliphatic carboxylic acid in which the aliphatic moiety contains up to about 30 carbon atoms and carbon dioxide in the presence of a solvent for the aliphatic carboxylic acid, a promoter and a microemulsion-forming amount of surfactant; and,
b. at least one organotin stabilizer.

16. The halogen-containing polymer composition of claim 15 wherein the halogen-containing polymer is a polyvinyl chloride homopolymer or a copolymer of vinyl chloride with an unsaturated monomer.

17. The halogen-containing polymer composition of claim 16 wherein the unsaturated monomers are selected from the group consisting of alpha olefins, acrylic acid, vinyl monomers, maleates and combinations thereof.

18. The halogen-containing polymer composition of claim 15 wherein the metal carbonate/carboxylate is selected from the group consisting of calcium carbonate, calcium carboxylate, zinc carbonate, zinc carboxylate and mixtures thereof.

19. The halogen-containing polymer composition of claim 15 wherein the carboxylate group is derived from an aliphatic carboxylic acid selected from the group consisting of caprylic acid, capric acid, lactic acid, lauric acid, myristic acid, myristoleic acid, decanoic acid, dodecanoic acid, pentadecanoic acid, palmitic acid, palmitoleic acid, margaric acid, stearic acid, 12-hydroxystearic acid, oleic acid, ricinoleic acid, linoleic acid, arachidic acid, gadoleic acid, eicosadienoic acid, behenic acid, erucic acid, tall oil fatty acids, rapeseed oil fatty acid, linseed oil fatty acid and mixtures thereof.

20. The halogen-containing polymer composition of claim 15 wherein the surfactant is selected from the group consisting of sorbitol, pentaerythritol, sugar alcohols and mixtures thereof.

21. The halogen-containing polymer composition of claim 16 wherein the organotin stabilizer is a alkyltin carboxylate, alkyltin mercaptide, or mixture thereof in which the alkyl groups contain from 1 to about 30 carbon atoms.

22. The halogen-containing polymer composition of claim 15 wherein the alkyltin mercaptide is selected from the group consisting of methyltin tris (2-ethylhexyl thioglycolate), dimethyltin bis (2-ethylhexyl thioglycolate), butyltin tris (lauryl mercaptide), dioctyl tin bis (isooctyl thioglycolate), octyltin tris (isooctyl thioglycolate) and mixtures thereof.

23. The halogen-containing polymer composition of claim 16 wherein the alkyltin carboxylate is selected from the group consisting of methyltin tris(2-ethyl hexyl maleate) and dimethyltin bis(2-ethyl hexyl maleate), dibutyltin bis (isooctyl maleate), and mixtures thereof.

24. The halogen-containing polymer composition of claim 16 wherein the weight ratio of (a) to (b) is from about 99:1 to about 1:99.

25. The halogen-containing polymer composition of claim 16 wherein the weight ratio of (a) to (b) is from about 10:90 to about 90:10.

26. The halogen-containing polymer composition of claim 16 wherein the weight ratio of (a) to (b) is from about 20:80 to about 50:50.

27. The halogen-containing polymer composition of claim 16 comprising at least one additional component selected from the group consisting of solvents, epoxies, 13-diketones, organic phosphites, antioxidants, radical scavengers, optical brighteners, light stabilizers, perchlorates, fillers, plasticizers, impact modifiers and pigments.

28. The halogen-containing polymer composition of claim 27 wherein the solvent is a paraffinic oil having a boiling point higher than about 120° C.

29. The halogen-containing polymer composition of claim 16 wherein the equivalent ratio of basic metal compound to aliphatic acid is about 1 to about 10.
